(19) United States
(12) Patent Application Publication
(10) Pub. No.: US 2026/0205046 A1
(43) Pub. Date: Jul. 16, 2026

(54) MODULE INTERFACE BRACKET WITH IN-SITU FORMED FASTENERS

(71) Applicant: Terabase Energy, Inc., Berkeley, CA (US)

(72) Inventors: Adam Hansel, Davis, CA (US); Cedric Boss, Richmond, CA (US); John Winston Ryan, Woodland, CA (US); Soren Jensen, Corte Madera, CA (US)

(73) Assignee: Terabase Energy, Inc., Berkeley, CA (US)

(21) Appl. No.: 19/022,953

(22) Filed: Jan. 15, 2025

(51) Int. Cl. H02S 20/20; B21D 39/03; F16B 5/06

(52) U.S. Cl. CPC H02S 20/20; B21D 39/031; F16B 5/0685

(57) ABSTRACT

The present invention discloses embodiments of a module interface bracket (MIB) that facilitates the automatic installation process for a torque tube for improved efficiency. The MIB may use two arms oriented in a way so that the arms overlap when closed around the torque tube. In the overlapping region, a fastener is applied in a direction parallel to the torque tube. This puts the fastener in shear rather than tension with a gap. Such a fastener has far greater consistency and reliability. Furthermore, a formed fastener may be created directly out of the overlapping regions of the arms by bending the ends of the overlapping regions around each for a locked joint, or using a die and punch to create a formed fastener.

### TECHNICAL FIELD

The present disclosure relates generally to solar panel installation. More particularly, the present disclosure relates to module interface brackets (MIBs) with in-situ formed fasteners for improved installation efficiency.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to improve on-site installation efficiency during the construction process.

Figure (“FIG.”) 1 shows a typical solar farm 105 comprising an array of installed solar tables 110. Each table comprises multiple solar panels 115. A large-scale solar farm typically includes thousands of solar panels that are located across a multi-acre terrain and that are electrically coupled to provide a source of energy. These large-scale systems are oftentimes located in remote areas and require a significant investment in materials, resources, and labor for on-site installation. It can be very challenging to maintain consistent installation processes at each point of installation within a construction site across large areas. These issues further contribute to an increase in the cost and complexity of a very cost-sensitive process.

In a typical installation process, multiple solar panels are securely aligned and attached to a shaft or torque tube (TT) to form a row of solar panels. A solar farm may comprise one or more solar arrays, with each solar array having multiple rows of solar panels. A row of solar panels may be supported by ground piles with the torque tube securely fastened to ground piles at a desired rotational angle such that the solar panels are oriented for maximum energy production efficiency.

Current methods of fastening a module interface bracket (MIB) to a TT use arms, brackets, or straps that wrap around the TT and are fastened together with a nut and bolt or a rivet that is in-plane with the MIB. This results in a fastener that is in tension. However, because of manufacturing tolerances, the parts being fastened may not be closed out, and there may be a gap between them. Therefore, it may be very difficult to get a consistent and reliable fastener as rivets and nut/bolts are designed for attaching two members that are in contact with each other without gap. Furthermore, nuts and bolts and two-part rivets present challenges for automation because there are multiple parts that have to be loaded, sorted, fed, and attached.

What is needed are systems, devices, and methods that facilitate installation automation to improve quality and efficiency of solar module-to-torque tube installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale. Functionally identical parts may be labeled with the same reference numeral.

FIG. 1 depicts a typical large-scale solar farm comprising an array of installed solar tables, with each solar table comprising multiple solar panels.

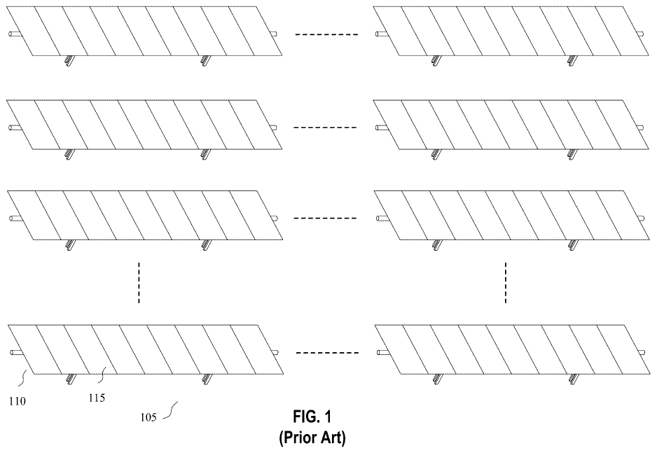

FIG. 2 shows an installation of solar tables on a construction site.

FIG. 3 shows a prior art MIB with an open strap for in-place fastening.

FIG. 4 shows a prior art MIB with a closed strap.

FIG. 5 shows another prior MIB for an octagonal torque tube for in-place fastening.

FIG. 6 shows an MIB with overlapped arms opened in accordance with various embodiments of the invention.

FIG. 7 shows an MIB with overlapped arms closed in accordance with various embodiments of the invention.

FIG. 8A shows a hole configuration for pre-loading MIB arms to a predetermined tension in accordance with various embodiments of the invention.

FIG. 8B shows a notch configuration for pre-loading MIB arms to a predetermined tension in accordance with various embodiments of the invention.

FIG. 8C shows a protrusion configuration for pre-loading MIB arms to a predetermined tension in accordance with various embodiments of the invention.

FIG. 8D shows a clinch configuration for pre-loading MIB arms to a predetermined tension in accordance with various embodiments of the invention.

FIG. 9 graphically shows a clinching process of using a die and a punch to create a formed fastener in accordance with various embodiments of the invention.

FIG. 10 shows a cross-sectional view of fastened overlapped sections in accordance with various embodiments of the invention.

FIG. 11 shows a process of securely attaching an MIB to a torque tube in accordance with various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of a self-closing rail.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently; and (4) certain functions may be performed concurrently or in sequence.

Furthermore, it shall be noted that many embodiments described herein are given in the context of the assembly and installation of large numbers of solar panels within a system, but one skilled in the art shall recognize that the teachings of the present disclosure may apply to other large and complex construction sites in which resources and personnel are difficult to manage and accurately predict. Additionally, embodiments of solar module-to-torque tube rails may be implemented in smaller construction sites or construction sites for applications other than solar farms.

In this document, “large-scale solar system” refers to a solar system having 1000 or more solar panels. The word “resources” refers to material, parts, components, equipment or any other items used to construct a solar table and/or solar system. The term “solar table” refers to a structural assembly comprising one or more photovoltaic (PV) or solar panels and/or one or more panel frames (or purlins) for panel support. Some types of solar panels may have electrical harnesses and supplemental structure that allow them to connect to other solar panels or foundations/piles while other types do not have this supplemental structure.

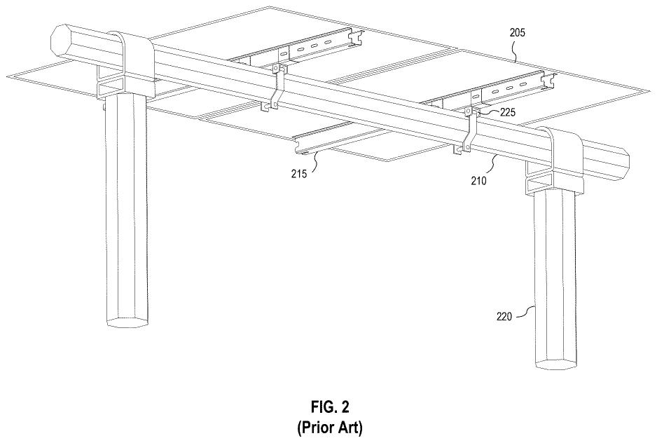

FIG. 2 shows an installation of solar panels in a construction site in accordance with various embodiments of the invention. Multiple solar panels 205 are securely aligned and attached to a shaft or torque tube 210 to form a row of solar panels, which are supported by ground piles 220. The torque tube is securely fastened to the ground piles and may be fixed in a desired rotational angle or be rotatable during operation such that the solar panels can operate continually under maximum energy production efficiency. To securely attach a solar panel to a torque tube, one or more panel frames 215 of the solar panel are firmly connected to a mounting rail or bracket 225 (aslo referred to as an MIB hereinafter), which is firmly clamped or coupled to the torque tube 210. To improve automation potential for PV applications, it is preferable to have parts that are both repeatable in their alignment behavior and are reasonably easy to automate. Current rail designs do not have repeatable attachment features for the rail-to-TT attachment. As a result, the rail-to-TT installation is typically implemented manually.

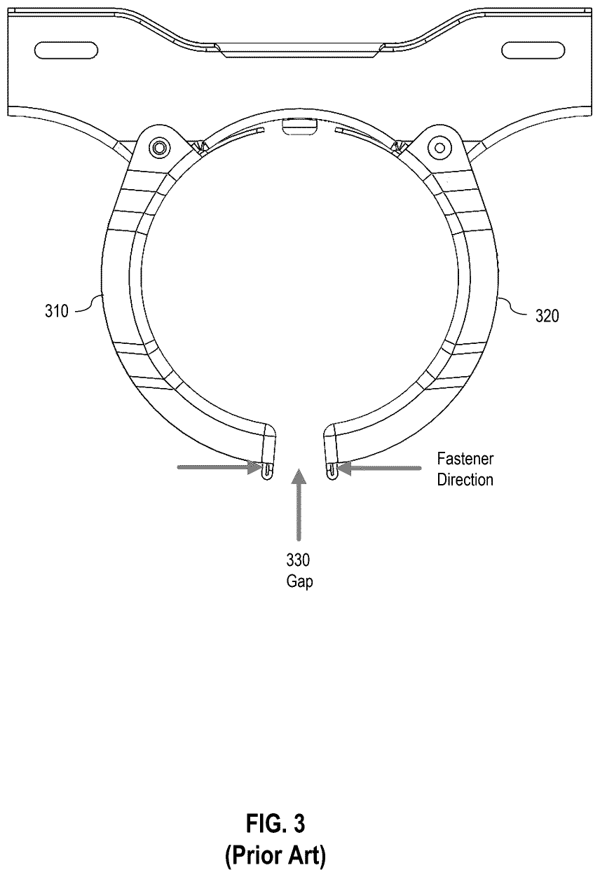

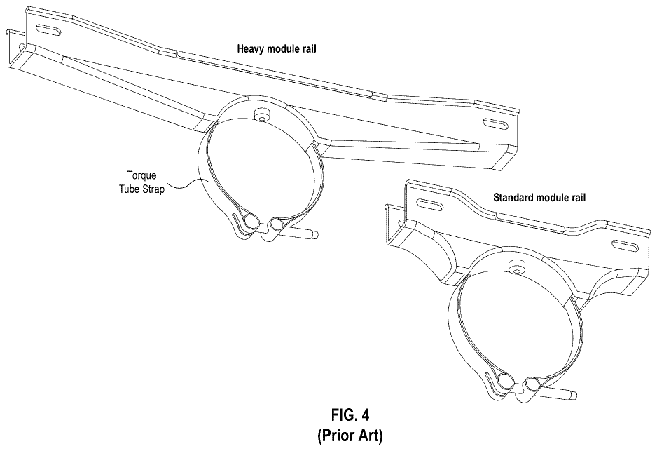

FIG. 3 shows a prior art rail with clamp comprising two arched arms for torque tube enclosing. A prepunched fastening hole is disposed at the end of each arched arm for installation of nut and bolt or rivet fasteners. FIG. 4 shows such strap-based rails rail with a closed strap. The rail uses a metal strap. For installation, an installer would need to open the strap wide enough such that the torque tube may be lifted to touch a concave surface of the rail for installation. The manual opening of the strap would make it challenging for automatic MIB-to-tube installation. The strap used in such a type of MIB is floppy and compliant. As a result, the nut and bolt must be pulled together manually to fasten together, which may bring extra challenging for automatic bolt installation.

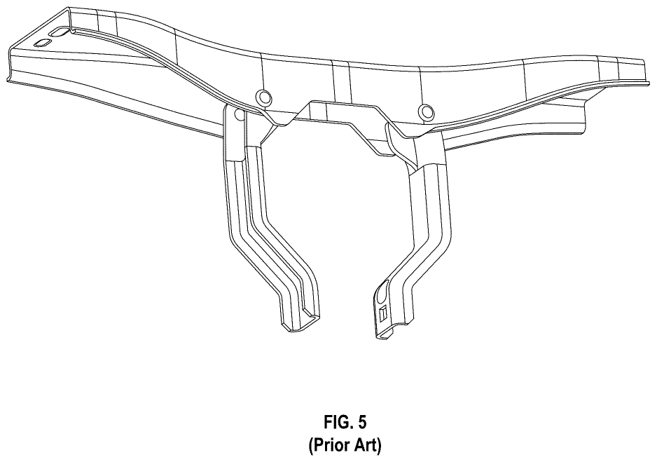

FIG. 5 shows another prior art MIB for an octagonal torque tube. The MIB has an octagonal clamp comprising two angled arms for torque tube enclosing. A pre-punched fastening hole is disposed at the end of each angled arm for installation of bolts/nuts which are used for clamp tightening. Similar to the MIB shown in FIG. 3, the pre-punched fastening holes on both arms may not be aligned perfectly due to inevitable manufacturing variations or geometric tolerances. Such misalignment could cause challenges for clamp tightening and thus make it difficult, if not impossible, to implement automatic rail-tube installation.

As shown in FIGS. 3-5, to fasten an MIB to a TT, arms, brackets, or straps are used to wrap around the TT and are fastened together with a nut and bolt or a rivet that is in-plane with the MIB. This results in a fastener that is in tension. However, because of manufacturing tolerances, the parts being fastened may not be closed out, and there may be a gap, e.g., the gap 330, between them. Therefore, it may be very difficult to get consistent and reliable clamping force in the fastener, as rivets and nut/bolts are designed for attaching two members that are in contact with each other without a gap. Furthermore, nuts and bolts and two-part rivets present challenges for automation because there are multiple parts that have to be loaded, sorted, fed, and attached

Described hereinafter are embodiments of an MIB that facilitates the automatic installation process for a torque tube for improved efficiency. The MIB may use two arms that overlap when closed around the TT. In the overlapping region, a fastener can be applied in a direction parallel to the TT. This puts the fastener in shear rather than tension with a gap. Such a joint has far greater consistency and reliability. Furthermore, it is possible to use a fastening method to form the fasteners directly out of the overlapping region of the arm by bending the ends of the arms around each other to form a locked joint, or using a die and punch to create a formed fastener (generally known as clinching).

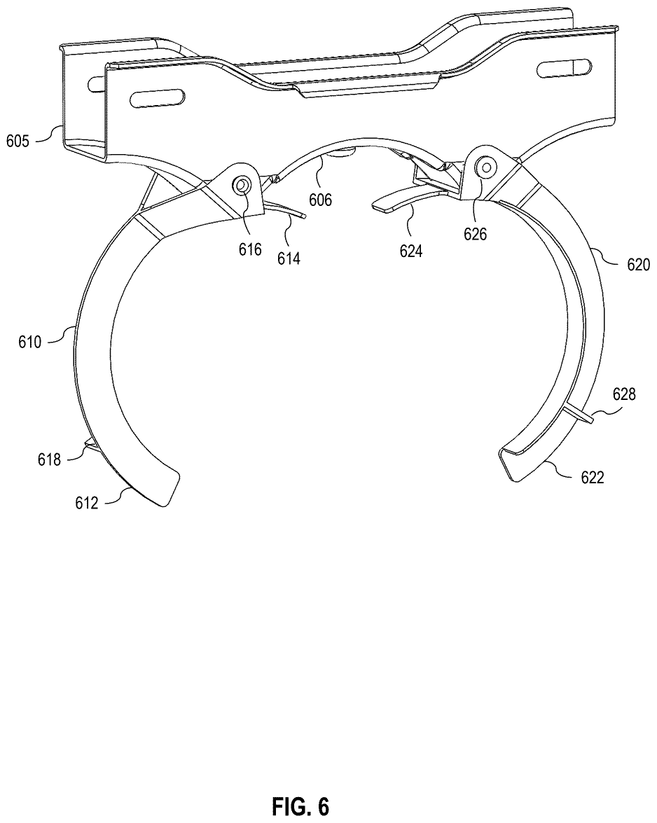

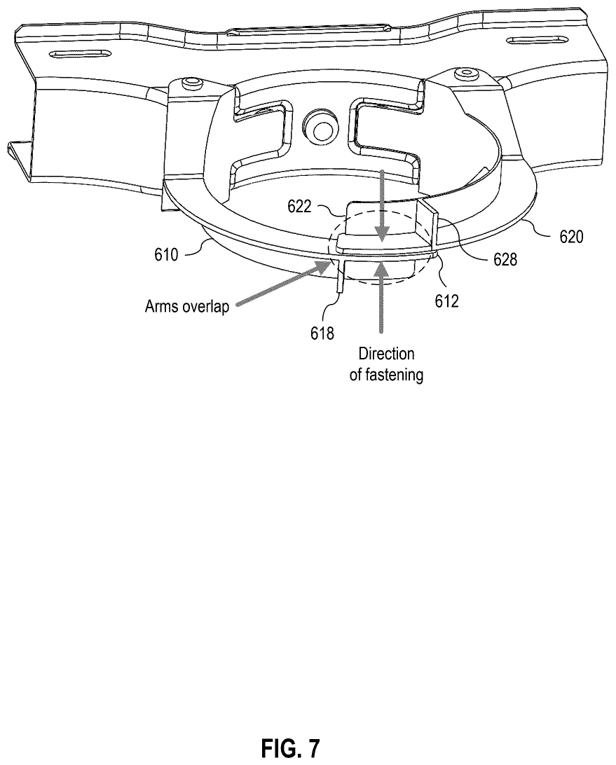

FIG. 6 shows an MIB with overlapped arms opened in accordance with various embodiments of the invention. The MIB has a bracket body 605, a first arm 610 comprising a first overlapping section 612, and a second arm 620 comprising a second overlapping section 622. The term “overlapping section” may be defined as a section on one arm that overlaps the other arm when both arms are in a closed position (as shown in FIG. 7). The first arm 610 is pivotably attached to the bracket body 605 around a first pivot axis 616. The second arm 620 is pivotably attached to the bracket body 605 around a second pivot axis 626. The first arm 610 and the second arm 620 may have a shape, e.g., an arc shape, as shown in FIG. 6, to match a torque tube. For example, the first arm 610 and the second arm 620 may have a bend with a desired angle, e.g., an octagonal bent angle (135°), to match a cross-section of a polygon (e.g., an octagon) torque tube. Altenatively, at least one of the first arm 610 and the second arm 620 may have a conforming section configured to hold the torque tube securely under stress. The arms may be made from steel, aluminum, metal alloy, acrylonitrile butadiene styrene (ABS), nylon, polytetrafluoroethylene (PTFE), or any other materials that are suitable for durable outdoor usage. Furthermore, the bracket body 605 may further comprise an indent 606 with a profile (an arc shape or a multilateral shape) to partially match the cross-section shape of the torque tube enclosed within the two arms.

In one or more embodiments, the first arm 610 further comprises a first balance section 614, and the second arm 620 further comprises a second balance section 624. The first arm 610 and the second arm 620 are kept in an open state by default. In the open state, the first arm 610 and second arm 620 are open enough to receive a torque tube unobstructively. It shall be noted that the open state may be kept by one or more means, such as a torsional spring disposed at each pivot axis, a friction fit at each pivot axis, a weight balance for each arm (as shown in FIG. 6), etc. For example, the first balance section 614 and the second balance section 624 may be weight balanced such that first arm 610 and the second arm 620 are kept in the open state when the first and second arms are free-swinging. The balance section 614/624 can also be actuated by means of a pneumatic, electrically or hydraulic actuator. Alternatively, a torsion spring (instead of a balance section) may be disposed on the first pivot axis and/or the second pivot axis to keep the arms in the open state by default. Such variations shall be still within the scope of this invention.

In one or more embodiments, the first arm 610 and the second arm 620 have an L-shaped cross-section and are at least partially offset to avoid interference when both arms are rotated into a closed state, as shown in FIG. 7 shows an MIB with overlapped arms closed in accordance with various embodiments of the invention. The first arm 610 may further comprise a first tag 618, which is approximately aligned to the edge of the second arm 620 when the first and second arms are in the closed position. Similarly, the second arm 620 may also further comprise a second tab 628, which is approximately aligned to the edge of the first arm 610 when the first and second arms are in closed position. Accordingly, the tabs may be used as references to verify whether the first and second arms are properly closed for fastening.

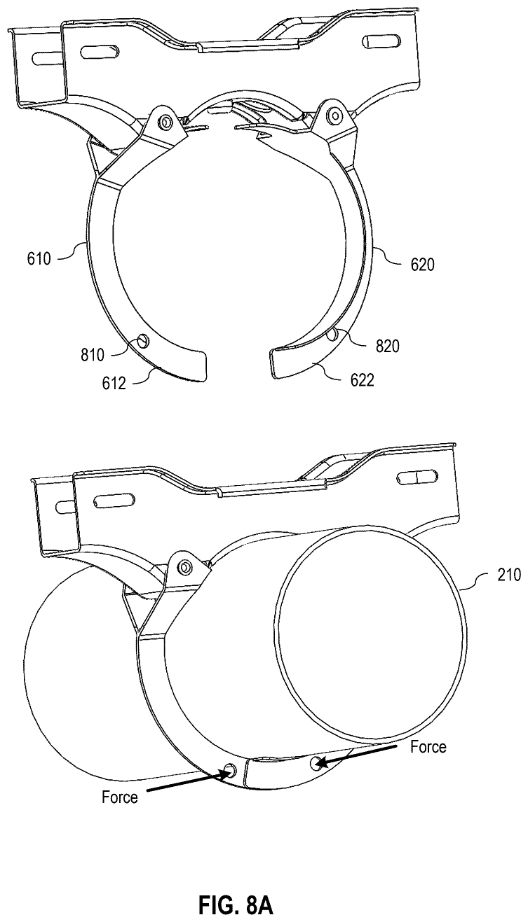

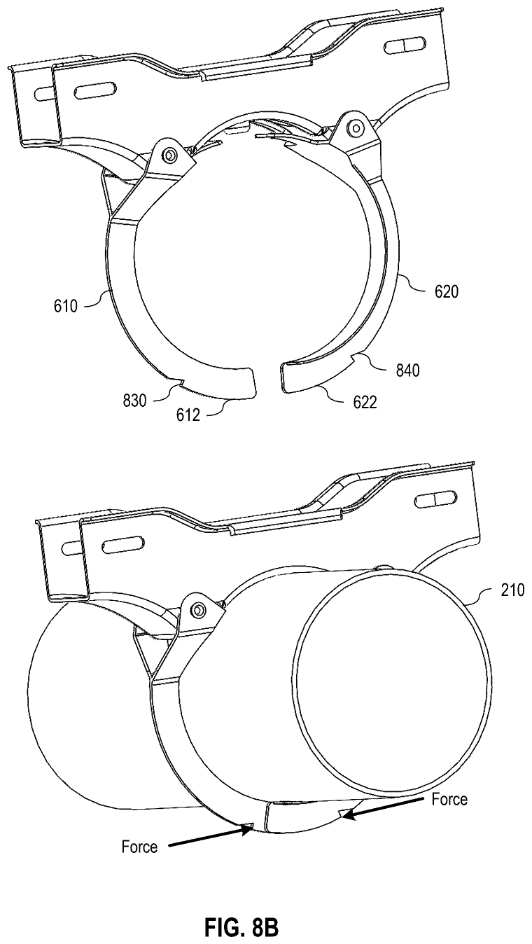

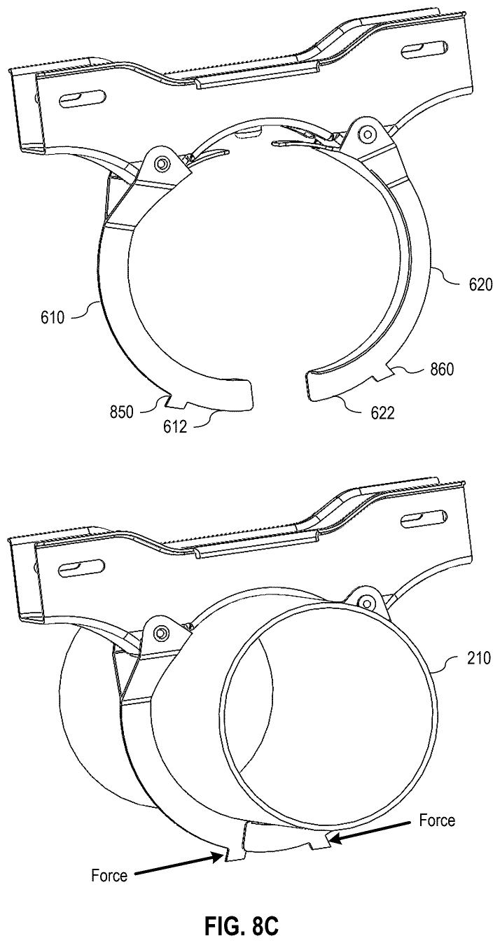

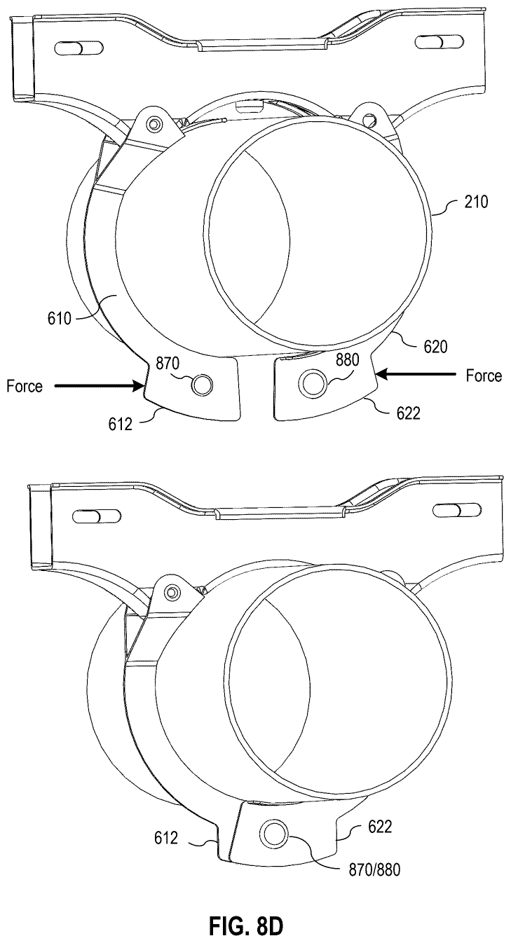

In one or more embodiments, the tabs may be used to receive a pre-loading force to close the two overlapping arms under a predetermined tension in the arms. A reliable tensioning of the closed arms is critical to the performance of the MIB. FIGS. 8A-8D show various pre-loading elements, beside the tabs, for pre-loading MIB arms to a predetermined tension in accordance with various embodiments of the invention.

FIG. 8A shows a hole configuration for pre-loading MIB arms. The first arm 610 and the second arm 620 incorporate a first pre-loading hole 810 and a second pre-loading hole 820, respectively. It shall be noted that these pre-loading holes face the same direction and therefore distinct from fastening holes shown in prior art. The pre-loading holes may be used to apply a pre-loading force (e.g., via a bent plier or engaging pins) to close the arms to a pre-determined stress to hold the torque tube 210 in position securely before the overlapping sections 612/622 are fastened together. FIG. 8B shows a notch configuration for pre-loading MIB arms. The first arm 610 and the second arm 620 incorporate a first pre-loading notch 830 and a second pre-loading notch 840, respectively. FIG. 8C shows a protrusion configuration for pre-loading MIB arms. The first arm 610 and the second arm 620 incorporate a first pre-loading protrusion 850 and a second pre-loading protrusion 860, respectively. Similar to the pre-loading holes, the pre-loading notches or protrusions may also be used to apply a pre-loading force to tighten the arms to the predetermined stress to hold the torque tube 210 securely. FIG. 8D shows a clinch configuration for pre-loading MIB arms. The first arm 610 and the second arm 620 incorporate a first clinch 870 and a second clinch 880, respectively. The overlapped sections 612/622 are applied a pre-loading force such that the first clinch 870 and the second clinch 880 is clinched to hold the torque tube 210 securely.

Once the arms 610 and 620 are in a proper closing position to enclose a TT with the predetermined tension, a fastener can be applied in the overlapping region in a direction that is parallel to a longitudinal axis of the TT. Such a parallel fastening results in a joint that has far greater consistency and reliability and puts the joint in shear rather than a tension with a gap. Furthermore, it is possible to create a fastener directly out of the overlapping region of the arm by bending the end of the arms around each other for a locked joint, or using a die and punch to create a formed fastener (generally known as clinching). Either method does not require pre-punched fastening holes to form and align during the fastening process, and thus provides a fastening approach without being influenced by MIB manufacturing tolerances.

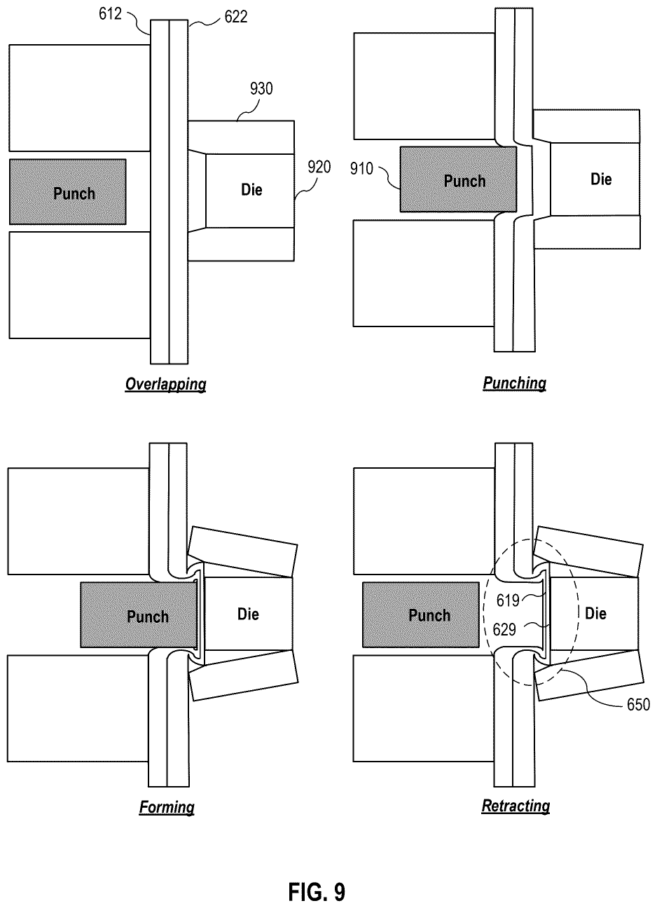

FIG. 9 graphically shows a clinching process of using a die and a punch to create a formed fastener in accordance with various embodiments of the invention. Clinching, also known as press joining, is a mechanical process of joining two metal layers together to create a tight and permanent joint. The clinching process does not require pre-punched fastening holes or consumable parts (e.g., bolts and nuts) for fastening alignment and thus provides a convenient and consistent fastening solution. The formed fastener, also called a clinch, has a clean finish and is tight, strong, and permanent.

As graphically shown in FIG. 9, the MIB clinching process may be described in four steps. In the overlapping step, the overlapping sections 612/622 of MIB arms 610/620 are aligned with a TT enclosed between the arms and are placed between a punch 910 and a die 920. The die is surrounded by an expandable sleeve 930, which may be extended outward under force.

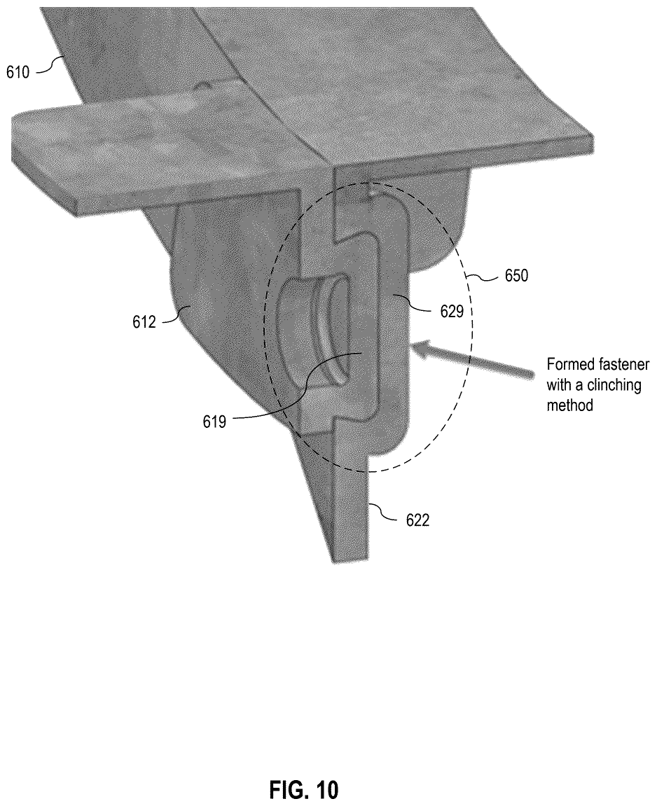

In the punching step, the punch 910 is pushed to past the surface of the overlapping section 612 without breaking or cracking the overlapping sections 612/622. In the forming step, the punch 910 presses the overlapping sections 612/622 against the die and causes a pressed area 619/629 of the overlapping sections 612/622 to flow outwards for an expanded bulge, thus creating a formed fastener 650. In the extracting step, the punch 910 is extracted with the formed fastener 650 joining the overlapping sections 612/622. A cross-sectional view of fastened overlapping sections is shown in FIG. 10 for an enlarged and more detailed view.

Besides the clinching process described above, various other fastening approaches may also be used to fasten the overlapping sections together without requiring pre-punched fastening holes. For example, a spot welding may be used to weld the overlapping sections together via one or more welding spots.

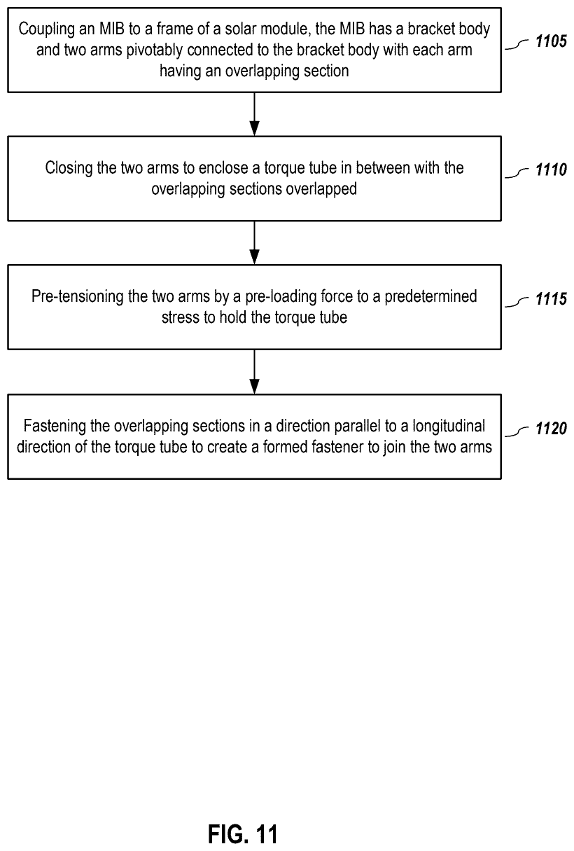

FIG. 11 shows a process of securely attaching an MIB to a torque tube in accordance with various embodiments of the invention. In step 1105, an MIB is securely coupled to a frame of a solar module. The MIB has a bracket body and two arms pivotably connected to the bracket body, with each arm having an overlapping section. In step 1110, the two arms are closed to enclose a torque tube with the overlapping sections overlapped. In step 1115, the two arms are pre-tensioned by a pre-loading or pre-tensioning force to a predetermined stress to hold the torque tube securely. The pre-loading force may be applied to pre-loading holes, notches, protrusion, or other geometric features incorporated on the arms. In step 1120, the overlapping sections are directly fastened in a direction parallel to the longitudinal direction of the torque tube to create a formed fastener to join the two arms. The formed fastener does not require pre-punched fastening holes or consumable parts. Such a fastening method may be implemented by bending the end of the arms around each other to form a locked joint, or using a die and punch to create a formed fastener.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A module interface bracket (MIB) comprising:
a bracket body;
a first arm pivotably attached to the rail body at a first pivot axis, the first arm comprising a first overlapping section; and
a second arm pivotably attached to the rail body at a second pivot axis, the second arm comprising a second overlapping section;
wherein when the first arm and the second arm are in a closed position to enclose a torque tube, the first overlapping section overlaps with the second overlapping section for fastening the first and second overlapping sections in a direction parallel to a longitudinal direction of the torque tube to create a fastener to join the first arm and the second arm.

2. The MIB of claim 1, wherein the first or second arm is free of pre-punched fastening holes.

3. The MIB of claim 1, wherein the first and second arms have a shape matching or partially matching a cross-section of the torque tube, or a conforming section configured to hold the torque tube securely under stress.

4. The MIB of claim 1, wherein the bracket body has an indent with a profile to partially match a cross-section of the torque tube.

5. The MIB of claim 1, wherein the first arm further comprises a first pre-loading element, the second arm further comprises a second pre-loading element, the first and second pre-loading elements are configured to receive a pre-loading force for pretensioning the first and second arms once the the first arm and the second arm are in the closed position to enclose the torque tube.

6. The MIB of claim 1, wherein the first arm and the second arm have an L-shaped cross-section and are at least partially offset to avoid interference when both arms are rotated into the closed position.

7. The MIB of claim 1, wherein the first arm further comprises a first balance section and the second arm further comprises a second balance section, the first and the second balance sections keep the first and second arms in an open state by default to receive the torque tube unobstructively.

8. The MIB of claim 1, wherein the fastener is a locked joint formed by bending ends of the first and second overlapping sections around each other.

9. The MIB of claim 1, wherein the fastener is a formed fastener created using a clinching process.

10. A method of solar module-to-torque tube installation, the method comprising:
coupling a bracket body of a module interface bracket (MIB) to a frame of a solar module, the MIB comprising a first arm and a second arm pivotably connected to the bracket body, the first arm comprising a first overlapping section and the second arm comprising a second overlapping section;
closing the two arms to enclose a torque tube in between with the first and second overlapping sections overlapped;
pre-tensioning the two arms by a pre-loading force to a predetermined stress to hold the torque tube; and
fastening the first and second overlapping sections in a direction parallel to a longitudinal direction of the torque tube to create a fastener to join the first and second arms.

11. The method of claim 10, wherein the first or second arm is free of pre-punched fastening holes.

12. The method of claim 10, wherein the first and second arms have a shape matching or partially matching a cross-section of the torque tube, or a conforming section configured to hold the torque tube securely under stress.

13. The method of claim 10, wherein the bracket body has an indent with a profile to partially match a cross-section of the torque tube.

14. The method of claim 10, wherein the first arm further comprises a first pre-loading element, the second arm further comprises a second pre-loading element.

15. The method of claim 14, wherein the first and second pre-loading elements are configured to receive a pre-loading force for pretensioning the first and second arms once the the first arm and the second arm are in the closed position to enclose the torque tube.

16. The method of claim 10, wherein the first arm and the second arm have an L-shaped cross-section and are at least partially offset to avoid interference when both arms are rotated into the closed position.

17. The method of claim 10, wherein the first arm further comprises a first balance section and the second arm further comprises a second balance section, the first and the second balance sections keep the first and second arms in an open state by default to receive the torque tube unobstrucitvely.

18. The method of claim 10, wherein the fastener is created by one or more of:
bending ends of the first and second overlapping sections around each other for a locked joint; and
spot welding to weld the first and second overlapping sections together via one or more welding spots.

19. The method of claim 10, wherein the fastener is created using a clinching process.

20. The method of claim 19, wherein the clinching process comprises steps of:
placing the first and second overlapping sections between a punch and a die, the die is surrounded by an expandable sleeve that is extendable outward under force;
pushing the punch to past a surface of the first overlapping section without breaking or cracking the first and second overlapping sections; and
pressing, by the punch, the first and second overlapping sections against the die and causing a pressed area to flow outwards for an expanded bulge, thus forming the fastener that joins the first and second overlapping sections.
